(19) United States
(12) Patent Application Publication
(10) Pub. No.: US 2003/0116701 A1
(43) Pub. Date: Jun. 26, 2003

(54) Software controled optical sensor for conveyors

(76) Inventors: Robert A. Nickels, Freeport, IL (US); Peter Dierauer, Freeport, IL (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/026,180

(22) Filed: Dec. 21, 2001

(51) Int. Cl. G06M 7/00; G01N 9/04

(52) U.S. Cl. 250/223 R

(57) ABSTRACT

A method and system for optically sensing the presence of an object on a conveyor is disclosed. Light reflected from an object transported on a conveyor is detected utilizing one or more optical components when the object enters a sensing zone. The reflected light can then be conditioned to provide a valid output signal, which is utilized to provide controlling information necessary to route the object to a proper location and prevent damage to the object from other objects as the object is being transported upon the conveyor. Optical components can be arranged so the light is reflected when the object enters the sensing zone, and this reflected light is then detected and conditioned to provide a valid output signal. Various lens devices and optical alignment arrangements permit control over the minimum and maximum sensing distance. An optical emitter, optical receiver, and/or one or more associated optical lenses may be connected by to a distributed controller.

### TECHNICAL FIELD

The present invention generally relates to electronic sensors. The present invention is additionally related to electronic sensors utilized in conveyor systems. The present invention is also related to optical sensing devices. The present invention is further related to optical emitters and optical detectors and methods and systems thereof.

### BACKGROUND OF THE INVENTION

Conveyor systems are generally utilized to move material through assembly processes and between operations in factories, distribution centers, and warehouses. A common requirement for many conveyor applications involves “zero pressure accumulation control,” which is generally a method for preventing damage caused by products running into each other as they are transported on conveyors. In addition, all conveyors require some form of “traffic control” in order to route items to the desired destination.

Typically, an industrial type photoelectric sensor is utilized to detect the presence of an item on a conveyor belt. The output from this sensor is generally connected to a controller, which can execute logic functions and generate required control outputs to an actuator mechanism that permits the item to be moved in a controlled manner along the conveyor.

Each photoelectric sensor typically includes an optical emitter and associated driver electronics, an optical receiver to detect the reflected light from an object being sensed, signal conditioning electronics, a power supply regulator, and output switching circuitry, which are configured together in a stand-alone package. Application specific integrated circuits (ASICS) are commonly utilized to reduce the complexity and size of the electronics.

As low-voltage DC motor-based technologies are applied to accumulation conveyor applications, the number of input and output connections, along with the physical locations of sensors and motors, dictates some form of distributed control solution. Such a distributed controller can typically perform the required control logic functions and, additionally, can directly control output devices. In the past, however, such devices relied heavily on hard-wired connections to conventional industrial photoelectric sensors for inputs. Because each sensor contains identical circuitry, this approach can add to system cost and limit reliability and flexibility.

Based on the foregoing, the present inventor has thus concluded that a need exists for a method and system which would reduce the cost and complexity of the sensing functions by replacing conventional photoelectric sensors with specialized optical sensing devices that are controlled largely by software executing on a distributed logic controlled device. This unique method and system is disclosed herein.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide improved electronic sensors.

The above and other aspects can be achieved as is now described. A method and system for optically sensing the presence of an object on a conveyor are disclosed herein. Light reflected from an object transported on a conveyor is detected utilizing one or more optical components when the object enters a sensing zone. The reflected light is conditioned to provide a valid output signal, which is utilized to provide controlling information necessary to route the object to a proper location and prevent damage to the object from other objects as the object is being transported upon the conveyor.

The light is emitted from a light emitter or optical emitter. The object reflects the emitted light, which can be thereafter detected utilizing one or more optical components. The optical components are arranged to provide control over a particular sensing distance, such as, for example, a maximum or minimum sensing distance. The optical components comprise one or more optical receivers, optical emitters and/or associated optical lenses. Such optical emitters, optical receivers and/or associated optical lenses are can be maintained within a sensor housing. Such optical components may be in turn connected to a distributed controller. The distributed controller can be configured to comprise electronic circuitry, which supplies power to the optical emitter, amplifies a signal output from the optical receiver, performs required signal conditioning and processing, and provides an interface to an associated microcontroller.

Because a microprocessor is usually present within distributed conveyor-control devices, integrating an optical sensing function into the distributed controller can increase control system reliability and cost-effectiveness. The method and system of the present invention, when implemented properly, can thus replace one or more traditional photoelectric sensors with a simple optical emitter/detector that shares a common hardware interface and implements as many functions as possible through software and algorithmic functions.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts a block diagram illustrating a conventional distributed accumulation controller application;

FIG. 2 is a block diagram illustrating a typical four-zone accumulation conveyor layout;

FIG. 3 depicts a block diagram illustrating a prior art photoelectric sensor design;

FIG. 4 illustrates a block diagram showing a software-controlled optical sensor design, in accordance with a preferred embodiment of the present invention; and

FIG. 5 depicts a block diagram illustrating a configuration in which a plurality of optical emitter-detector pairs may be connected to a single controller as may be desired, in accordance with a preferred embodiment of the present invention.

### DETAILED DESCRIPTION OF THE INVENTION

The particular values and configurations discussed in these non-limiting examples can be varied and are cited merely to illustrate embodiments of the present invention and are not intended to limit the scope of the invention.

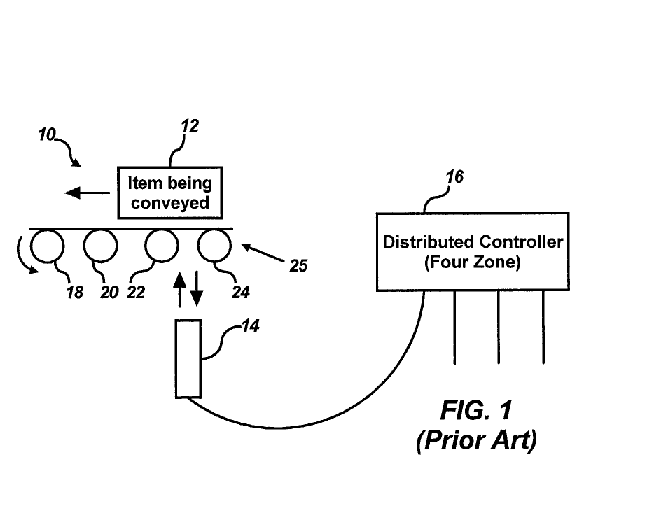

FIG. 1 depicts a block diagram 10 illustrating a conventional distributed accumulation controller application. FIG. 1 thus depicts a conventional conveyor system, which is generally configured from a number of sections that are assembled together to create conveyors of desired length and form. A common section, for example, is generally 10 feet in length, having four 30-inch accumulation zones. As a result, the most commonly utilized distributed controllers are designed to control four zones (i.e., interfaces for four sensors and four output devices). Thus, as indicated in FIG. 1, a distributed controller 16 (i.e., a four zone distributed controller) is linked to a diffuse-type photo sensor 14. An item 12 can be conveyed upon a conveyor 25 composed of rollers 18, 20, 22 and 24. Such a conveyor can be utilized to move material through an assembly process, for example, and between operations in factories, distribution centers, warehouses, and so forth.

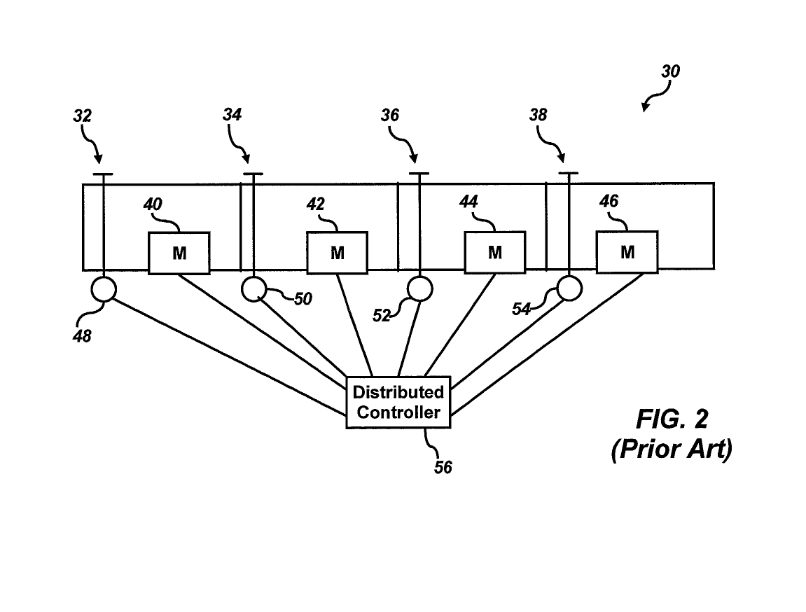

FIG. 2 illustrates a block diagram 30 illustrating a typical four-zone accumulation conveyor layout. In FIG. 2, a distributed controller 56 is generally linked to DC motors 40, 42, 44, and 46. FIG. 2 generally illustrates an arrangement of a typical 10-foot conveyor section having four 30-inch zones and a distributed controller 56 for zero pressure accumulation. Photo sensors 32, 34, 36, and 38 are also depicted in FIG. 2 and can be connected to distributed controller 56 via connectors 48, 50, 52, and 54. When applied to conveyor control, up to four photoelectric sensors (i.e., photo sensors 32, 34, 36, and 38) can be interfaced to a single distributed controller (e.g., distributed controller 56).

When this happens, much of the electronic circuitry contained in each sensor 32, 34, 36 and 38 becomes redundant. Distributed controller 56 already contains power regulation circuitry and can easily accommodate signal-conditioning circuitry currently built into each of the multiple sensors. Thus, as indicated in FIG. 1 and FIG. 2, a distributed controller typically incorporates the functions of four accumulation zones, including four discrete photoelectric sensors.

Thus, when four photoelectric sensors 32, 34, 36, and 38 are connected in combination with a distributed controller 36, as illustrated in FIG. 2, redundancies can occur which add cost and complexity and diminish reliability. For example, a total of five printed circuit boards and five power regulation circuits can exist within a single 10 foot conveyor section, all of which have the potential to fail, thus decreasing system reliability. The present invention eliminates duplication of functionality by integrating the sensing circuitry into the controller and substituting the software for hardware where possible.

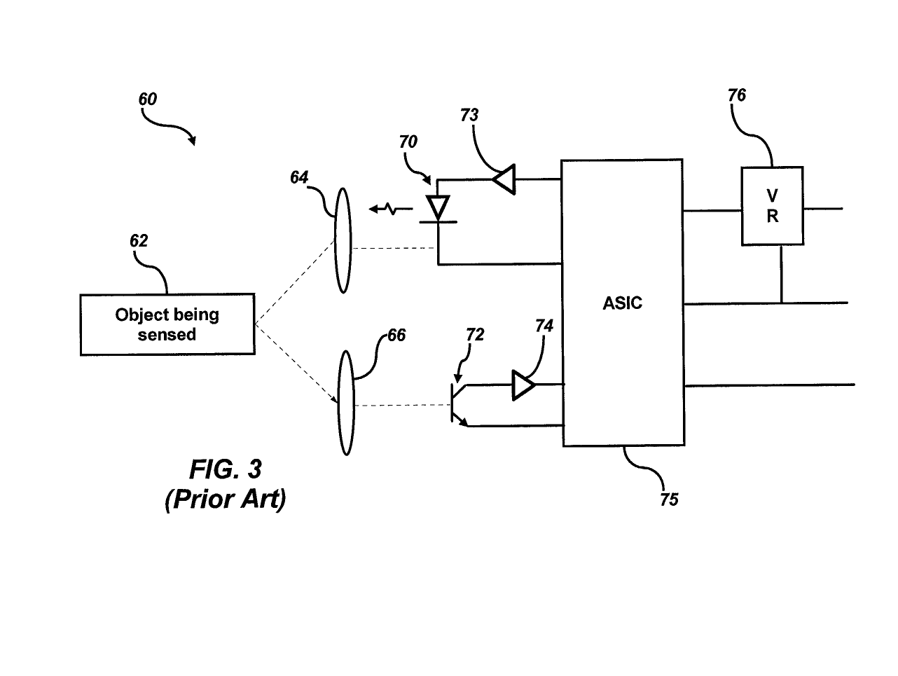

FIG. 3 depicts a block diagram 60 illustrating a prior art photoelectric sensor design. An object 62 being sensed is positioned within a detecting distance of lenses 64 and 66. As illustrated in FIG. 3, each of the aforementioned sensors can incorporate an optical emitter 70, an optical receiver 72, an optical driver 73, an optical preamp 74, and an ASIC 75, which in turn is generally connected to a voltage regulator 76. Note that in FIG. 3, each of these elements is illustrated as a discrete block. Block diagram 60, however, is intended to depict the functional equivalents.

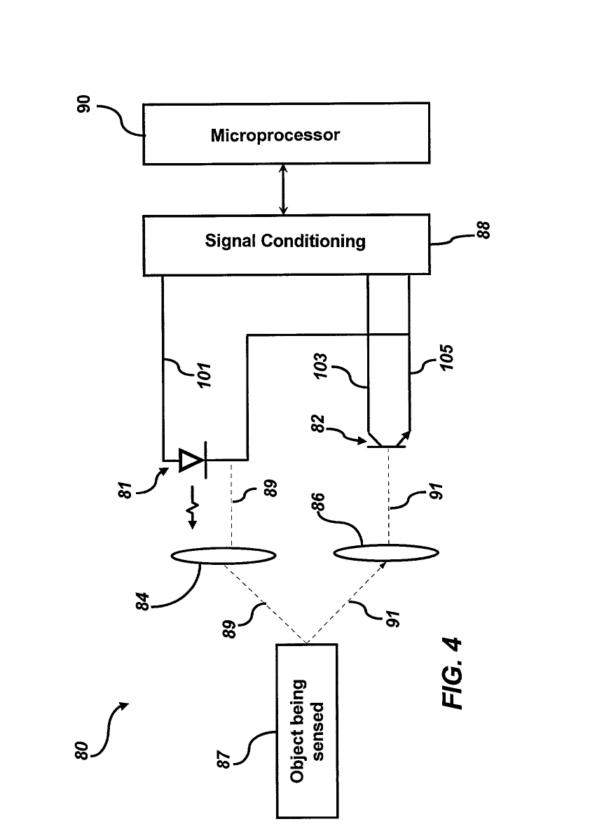

FIG. 4 illustrates a block diagram 80 illustrating a software-controlled optical sensor design, in accordance with a preferred embodiment of the present invention. As indicated in FIG. 4, optical components can be arranged so that emitted light 89 is reflected by object 87 (i.e., the object being sensed) when the object enters a sensing zone. Light is generally emitted from optical emitter 81 and passes through lens 84. Reflected light 91 then passes through lens 86 and is detected by optical receiver 82. The reflected light 91 is thus detected and conditioned via signal conditioning module 88 to provide a valid output signal.

Note that signal-conditioning module 88 is also connected to microprocessor 90. Various lenses and optical alignment arrangements permit control over the minimum and maximum sensing distance. As illustrated in FIG. 4, the optical emitter 81 and optical receiver 82 are retained in a sensor housing (although not necessary), along with associated optical lenses 84 and 86, and may be connected by means of three wires 101, 103 and 105 to a distributed controller comprising signal conditioning module 88 and microprocessor 90.

Internal to such a distributed controller, electronic circuitry can be provided which supplies power to optical emitter 81 and amplifies the signal received from optical receiver 82. Such electronic circuitry can also perform any required signal conditioning (i.e., signal conditioning module 88) or processing (e.g., analog or digital) and can also provide an appropriate interface to a microcontroller.

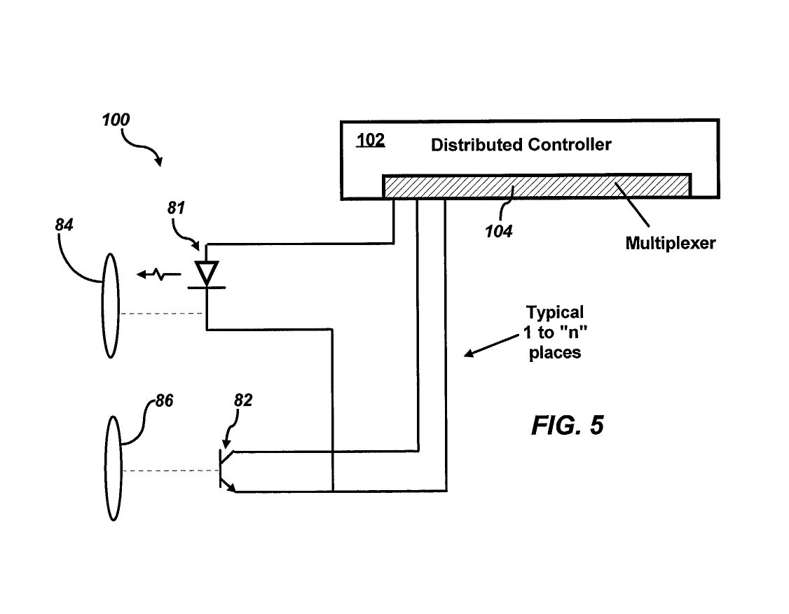

FIG. 5 depicts a block diagram 100 illustrating a configuration in which a plurality of optical emitter-detector pairs may be connected to a single controller as may be desired, in accordance with a preferred embodiment of the present invention. Note that in FIGS. 4 and 5 like parts are indicated by identical reference numerals. Thus, optical emitter 81 (i.e., a light emitter) is generally connected to distributed controller 102. Optical emitter 81 transmits light to optical receiver 82. Distributed controller 102 is generally connected to optical receiver 82. Optical receiver 82 receives light transmitted from lens 86 and is generally connected to distributed controller 102. Distributed controller 102 can also be integrated with or connected to a multiplexer 104. Optical emitter 81 and optical receiver 82 thus can comprise an optical emitter/receiver pair.

The present invention thus offers a number of advantages over conventional methods and systems. The present invention, as disclosed herein, is highly scalable. The number of emitter/receiver pairs connected to a distributed controller may be varied according to the design of the control architecture. For example, a common configuration for conveyor control involves a four-zone controller. In this case, four optical pairs can be connected to a single controller, either with direct connection to the microcontroller I/O pins or via a multiplexer circuit that permits the microcontroller to access each individual optical sensor under program control. Various combinations of I/O design exist in the art to minimize the cost of detecting or “scanning” the sensor inputs without the need for a custom ASIC in each sensor. The approach of the present invention, however, may also be utilized with a single-zone controller, where only one sensor is required by eliminating the multiplexing circuitry and interfacing directly to the microcontroller. In this manner, the design is scalable from 1 to n sensors per controller, which is indicated in FIG. 5.

The present invention may also be configured with an optical driver, which can power the optical emitters individually in synchronism with the input read function, either by means of a separate microcontroller output for each emitter or by means of a demultiplexer circuit that permits access to each emitter under program control. Various methods exist within the art to provide the desired functionality.

The present invention also permits multiple sensors to share common interface circuitry within the distributed controller. One implementation of this is multiplexing, wherein each optical emitter can be energized in time sequence, and each corresponding optical detector may be scanned to determine the presence of an object in the same time sequence. This approach makes it possible to create a controller having only one set of electronics, which can be shared among a multitude or plurality of emitter/detector pairs. By synchronizing the time sequence, it is possible to minimize false signals from other optical sources.

The present invention can also utilize a common power supply, which reduces the associated cost and increases the reliability through the use of only one power supply regulation circuit for both the controller and sensor(s). The present invention additionally employs enhanced software control features. Various schemes can be utilized, for example, to ensure that the signal from the optical detector is valid (i.e., that an object is present in the conveyor zone). Such techniques include time delays, debouncing, and time-based averaging or sampling, prior to determining that a particular optical signal is in fact valid. The present invention can thus move all functions under software control into a distributed controller microprocessor, thereby permitting much greater flexibility and the use of much more sophisticated algorithms than presently available through conventional techniques.

Also, the emitter/detector and distributed controller can be integrated into a single package, if desired, along with any other desired conveyor control components or elements. Additionally, because the present invention permits a significant reduction in the size of the sensor, designers are provided greater freedom in sensor location and mounting means.

Indicators, such as, for example, LEDs or another remote configuration device, may be attached to the distributed controller for ease of setup or troubleshooting. Having all such indicators accessible from a single location eliminates the need to provide visible indicators on each sensor, as is commonly accomplished with industrial photoelectric sensors today, further reducing costs while maintaining functionality.

Because the present invention utilizes the same number of electrical connections to the optical assembly, existing interconnection methods, such as, for example, M12 connectors or RJ-45 type telephone connectors, may still be utilized. An alternative implementation of the present invention can involve the co-location of emitter and detector components in the distributed controller, with either single or dual fiber-optic cables utilized to conduct light to and from the sensing zone. This implementation would reduce the space required for sensing the object.

A VCSEL laser diode may be substituted for a standard IR emitter for greater range and control over optical characteristics. System costs may be reduced and reliability increased through the elimination of unnecessary printed circuit boards, soldered connections, and active components.

Because all the sensors can be co-located with a microprocessor, any desired internal signal is readily available for diagnostics that may be deemed appropriate. For example, if the designer wishes to implement a variable drive circuit to the optical emitter to compensate for dust or misalignment, this can be accomplished with no change to the optical emitter/detector assembly. Because signal processing and validation features generally fall under software control, modifications can be readily made to these algorithms to provide additional diagnostics. For example, an “up/down” counter can provide an indication of the number of false trips; or a time can be utilized, which indicates that a sensor had been blocked. Additionally, feedback from the input circuit can indicate a wiring fault.

It is also important to note that the term “module” as utilized herein may refer to a physical hardware device and/or a collection of routines, subroutines and data structures thereof that perform particular tasks or which can implement a particular abstract data type. Thus, a “module” may be configured as a software module. Such a module may comprise at least two portions or functions. First, a module may include an interface, that lists the variables, constants, data types, routines and subroutines that may be accessible by other modules, routines, or subroutines. Second, a module may include an implementation, which is generally private (i.e., accessed only by that module) and which includes a source code that actually may implement the routines, subroutines, and/or data types within the module. The term “module” is well known in the art and thus can refer to a software module and/or a self-contained module of data and may be implemented strictly through software and/or in association with a physical hardware device.

When referring, for example, to a “detecting module” for detecting light reflected from an object transported on a conveyor, utilizing at least one optical component when the object enters a sensing zone, such a module may comprise software, hardware and/or a combination of software and/or hardware. The same holds true, for example, when referring to a “conditioning module” for conditioning the reflected light to provide a valid output signal. Thus, the term “module” has several possible meanings, all of which are valid alone or in combination with one another in light of the disclosed present invention.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. For example, it can be appreciated by those skilled in the art that the present invention described herein can apply to automotive sensor applications. The description as set forth is not intended to be exhaustive nor to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments of an invention in which an exclusive property or right is claimed are defined as follows:

1. A method for optically sensing the presence of an object on a conveyor, said method comprising the steps of:
detecting light reflected from an object transported on a conveyor utilizing at least one optical component when said object enters a sensing zone; and
conditioning said reflected light to provide an output signal, which is utilized to provide controlling information necessary to route said object to a proper location and prevent damage to said object from other objects as said object is being transported upon said conveyor.

2. The method of claim 1 further comprising the step of:
emitting light, such that said light is reflected by said object and thereafter detected utilizing said at least one optical component.

3. The method of claim 1 further comprising the step of:
arranging said at least one optical component to provide control over a sensing distance.

4. The method of claim 3 wherein said sensing distance comprises a maximum sensing distance.

5. The method of claim 3 wherein said sensing distance comprises a minimum sensing distance.

6. The method of claim 1 wherein said at least one optical component comprises an optical receiver.

7. The method of claim 1 wherein said at least one optical component comprises an optical emitter.

8. The method of claim 1 wherein said at least one optical component comprises a plurality of optical components.

9. The method of claim 8 further comprising the step of:
configuring said plurality of optical components to comprise at least one optical emitter, at least one optical receiver, and at least one associated optical lens.

10. The method of claim 9 further comprising the step of:
maintaining said at least one optical emitter, said at least one optical receiver, and said at least one associated optical lens in a sensor housing.

11. The method of claim 10 further comprising the step of:
connecting said plurality of optical components to a distributed controller.

12. The method of claim 11 further comprising the step of:
configuring said distributed controller to comprise electronic circuitry which supplies power to said at least one optical emitter, amplifies a signal output from said at least one optical receiver, performs required signal conditioning and processing, and provides an interface to a microcontroller.

13. A method for optically sensing the presence of an object on a conveyor, said method comprising the steps of:
arranging a plurality of optical components to provide control over a sensing distance;
configuring said plurality of optical components to comprise at least one optical emitter, at least one optical receiver, and at least one associated optical lens;
detecting light reflected from an object transported on a conveyor utilizing said plurality of optical components when said object enters a sensing zone; and
conditioning said reflected light to provide an output signal, which is utilized to provide controlling information necessary to route said object to a proper location and prevent damage to said object from other objects as said object is being transported upon said conveyor.

14. A system for optically sensing the presence of an object on a conveyor, said system comprising:
detecting module for detecting light reflected from an object transported on a conveyor utilizing at least one optical component when said object enters a sensing zone; and
conditioning module for conditioning said reflected light to provide an output signal, which is utilized to provide controlling information necessary to route said object to a proper location and prevent damage to said object from other objects as said object is being transported upon said conveyor.

15. The system of claim 14 further comprising a light emitter, wherein light from said light emitter is reflected by said object and thereafter detected utilizing said at least one optical component.

16. The system of claim 14 wherein said at least one optical component is arranged to provide control over a sensing distance.

17. The system of claim 16 wherein said sensing distance comprises a maximum sensing distance.

18. The system of claim 16 wherein said sensing distance comprises a minimum sensing distance.

19. The system of claim 15 wherein said at least one optical component comprises an optical receiver.

20. The system of claim 15 wherein said at least one optical component comprises an optical emitter.

21. The system of claim 14 wherein said at least one optical component comprises a plurality of optical components.

22. The system of claim 21 wherein said plurality of optical components is configured to comprise at least one optical emitter, at least one optical receiver, and at least one associated optical lens.

23. The system of claim 22 wherein said at least one optical emitter, said at least one optical receiver, and said at least one associated optical lens are maintained in a sensor housing.

24. The system of claim 24 wherein said plurality of optical components are connected to a distributed controller.

25. The system of claim 24 wherein said distributed controller is configured to comprise electronic circuitry which supplies power to said at least one optical emitter, amplifies a signal output from said at least one optical receiver, performs required signal conditioning and processing, and provides an interface to a microcontroller.

26. A system for optically sensing the presence of an object on a conveyor, said system comprising:
a plurality of optical components arranged to provide control over a sensing distance;
said plurality of optical components configured to comprise at least one optical emitter, at least one optical receiver, and at least one associated optical lens;
detecting module for detecting light reflected from an object transported on a conveyor utilizing said plurality of optical components when said object enters a sensing zone; and
conditioning module for conditioning said reflected light to provide an output signal, which is utilized to provide controlling information necessary to route said object to a proper location and prevent damage to said object from other objects as said object is being transported upon said conveyor.
